(19) United States
(12) Patent Application Publication
(10) Pub. No.: US 2005/0167455 A1
(43) Pub. Date: Aug. 4, 2005

(54) Tamper-proof bottle cap

(76) Inventor: Bang Bin Yim, Seoul (KR)

Correspondence Address: DICKSTEIN SHAPIRO MORIN & OSHINSKY LLP, 2101 L Street, NW, Washington, DC, 20037, US

(21) Appl. No.: 10/997,911

(22) Filed: Nov. 29, 2004

(30) Foreign Application Priority Data
Feb. 2, 2004 (KR) 20-2004-0002420

(51) Int. Cl. B67D 5/32

(52) U.S. Cl. 222/564; 222/567

(57) ABSTRACT

A tamper-proof bottle cap structurally fixed to an opening of a bottle for guiding the flow of contents in the bottle such as beverage, liquor or the like and designed to prevent foreign objects or fabricated materials from entering the bottle from outside is disclosed. A valve member opens and closes a vertical hole of an inner cover and simultaneously controls the flow of contents discharged via the vertical hole, and a baffle valve coupled to an upper side of the valve member is made to transmit a rotational force of an outer cover and to block the valve member from the outside, such that a spiral fluid current can be formed regardless of the tilting angle of the bottle when the contents of the bottle such as beverage, liquor or the like are poured out. The speed of fluid current of the contents can be constantly maintained, making it possible to discharge the contents in an appropriate quantity and to reduce the friction sound. The valve member and the baffle valve are closed by resistance generated by the input of foreign substances, thereby preventing the contents from being tampered with foreign materials.

### FIELD OF THE INVENTION

The present invention relates to a bottle cap for containing beverage or liquor and, more particularly, to a tamper-proof bottle cap adapted to have a function of preventing foreign objects from entering the bottle.

### BACKGROUND OF THE INVENTION

Generally, a bottle cap is installed at an opening of a bottle in which beverage or liquor is contained. A consumer seals the opening of the bottle with the bottle cap after drinking the beverage or liquor and stores the remaining liquids for later consumption. The bottle cap is conventionally classified into two types: one type is pressed into the opening of the bottle for sealing the opening; and the other type is screwed onto the threaded neck of the bottle.

However, these types of bottle caps tend to be easily separated or unscrewed from the neck of the bottle, allowing for easy tampering by dishonest users. For example, a consumed or discarded bottle can be collected, filled with other liquids or foreign contents, re-sealed with a new bottle cap and circulated to the public. Consumers purchasing the bottle may not know that tampering of the liquids contained in the bottle has occurred.

Particularly, when a bottle contains high-priced liquor, which has the most frequent tampering occurrence, consumers may fall prey to deceitful tampering and ruin their health while the person who has tampered the bottle can benefit from huge unfair profits. There is a problem in that if a bottle is to be misused to hurt a person's health or to allow a dishonest person to make an unfair profit, input of foreign objects or tampered contents into the bottle can occur without restraint.

In order to address the above-mentioned problems, various types of tamper-proof bottle caps have been disclosed. One of the types previously proposed is Korean Utility Model No. 0304873, entitled “Forgery Preventive Bottle Cap,” exploded views of which are illustrated in FIGS. 5 and 6.

The forgery preventive bottle cap (30), which is push-fitted into an opening (3a) of a neck of a bottle according to Korean Utility Model No. 0304873, includes an inner cover (32) insertedly fixed at a lower end of the opening (3a) of the bottle (3) for guiding an outflow of contents thereof, a valve member (34) inserted via an upper side of the inner cover (32) and vertically moving for opening and closing a passage of the inner cover (32) and forming a spiral water current for controlling a current speed when contents of the bottle (3) flow out, an intermediate cover (36) inserted into an upper circumference of the inner cover (32) for guiding the outflow of the contents, and an outer cover (38) opened and closed by threaded engagement at an upper circumference of the intermediate cover (36) for applying pressure to or releasing the valve member (34).

The inner cover (32) is formed at the center of a cylindrical body (32a) with a vertical hole (32b) having an opening each at an upper and a lower side thereof, where an inner diameter of the vertical hole (32b) maintains a tolerance of, for example, an approximately φ1 mm relative to a circumference of a screw unit (described later) of the valve member (34). At an upper circumference of the vertical hole (32b), there is integrally formed a contact protruder (32c) for increasing tightness when a baffle board (described later) of the valve member (34) is tightened. At an upper circumference of the body (32a), there is integrally formed a flange (32e) having a pressure protruder (32d) so that an upper surface of a flange (3b) of the bottle (3) can come in close contact with a lower surface of a flange (described later) of an intermediate cover (36).

Furthermore, at a circumference between the contact protruder (32c) of the flange (32e) relative to the upper end of the body (32a), there is integrally formed an upper coupling surface (32f) so as to be press-fitted into a lower end of the intermediate cover (36). A lower coupling surface (32g) is formed at an inner lower circumference of the flange (32e) so as to be press-fitted into the bottle (3). At an inner lower circumference of the vertical hole (32b), there is integrally formed a cross-shaped rib (32i) centrally disposed with a support hole (32h) so that a lower end of the valve member (34) can be hinged for vertical and horizontal movement.

The valve member (34) is integrally formed at a middle stair thereof with a disc-shaped baffle board (34a) having an area for being tightened with or being separated from the contact protruder (32c) formed at an upper end of the vertical hole (32b) of the inner cover (32). At a middle upper central surface of the baffle board (34a), there is integrally formed an upper support axis (34b) so as to be inserted into a lower center of the intermediate cover (36) for vertical and horizontal movement. A locking groove (34c) of a predetermined depth is formed at an upper center surface of the support axis (34b) so that a locking axis (described later) can be inserted into a bottom central surface of an outer cover (38) without running idle.

At a lower center surface of the baffle board (34a), there is integrally formed a screw unit (34d) so as to be inserted into the vertical hole (32b) of the inner cover (32) for vertical and horizontal movement along with the baffle board (34a) and to form a spiral water current when contents pass therethrough for maintaining a flow speed at a prescribed level. At a lower center of the screw unit (34d), there is integrally formed a lower support axis (34e) so as to be hinged at a support hole (32h) formed at a lower end of the vertical hole (32b) of the inner cover (32) and for a circumference of the screw unit (34d) to supportively maintain a tolerance of, for example, approximately φ1 mm relative to an inner circumference of the vertical hole (34e).

The baffle board (34a) is formed with a larger outer diameter than that of the screw unit (34d), and the screw unit (34d) has spiral fans (S), each fan spaced 180 degrees apart so that contents can pass therethrough forming a spiral water current, and hollow parts of the fans at the screw unit (34d) are streamlined in order to minimize resistance with the contents and to allow the contents to evenly flow.

The intermediate cover (36) is formed with a connecting cap (36c) centrally having a through hole (36b) wherein an upper support axis (34b) of the valve member (34) is inserted into an upper central surface of the cylindrical body (36a) to concentrically match with the locking groove (34c) centrally formed on the upper surface of the upper support axis (34b). The connecting cap (36c) is integrally connected with an inner circumference of the body (36a) by a plurality of ribs each evenly spaced out along the circumferential margin between which outlets (36e) are formed.

The body (36a) is integrally formed at an outer upper circumference thereof with an upper flange (36f) so as to tightly contact a bottom surface of the outer cover (38). The body (36a) is further integrally formed at a lower circumference thereof with a lower flange (36h) having a plurality of pressure protruders (36g) thereunder so as to tightly contact the flange (32e) of the inner cover (32) and to mesh with the upper pressure protruders (32d) of the flange (32e) without running idle. The body (36a) is also integrally formed at an intermediate circumferential stair thereof with a male screw surface (36i) in order to correspondingly mesh with the outer cover (38).

The outer cover (38) is a cap having an opening thereunder and is vertically and centrally formed with a cross-shaped locking axis (38a) fixed into the locking groove (34c) of the valve member (34) via the through hole (36b) of the intermediate cover (36) to simultaneously rotate the valve member (34) and to apply pressure to the lower end.

The outer cover (38) is also integrally formed at a bottom middle circumference thereof with a contact protruder (38b) so as to tightly contact the upper flange (36f) of the intermediate cover (36) and is further integrally formed at an inner circumference thereof with a female screw surface (38c) so as to correspondingly couple with the male screw surface (36i) formed at the peripheral surface of the intermediate cover (36).

The valve member of the above-mentioned prior art is directed to prevent influx of impurities from outside and simultaneously to let contents in the bottle to spirally flow out from the bottle.

However, there is a drawback in the valve member according to the prior art thus described in that, because a locking groove is formed at a central upper surface where a distal end of the locking axis of the outer cover (38) is coupled. A dishonest person can insert impurities by holding an inner circumference of the locking groove and pulling the valve member toward an outside lid via the locking groove and to let the inside of the bottle communicate with the outside thereof.

### SUMMARY OF THE INVENTION

The present invention is disclosed to solve the afore-mentioned drawback and it is an object of the invention to provide a tamper-proof bottle cap adapted to allow a screw-typed valve member to close by resistance of pressure (current pressure) applied from foreign objects, impurities or tampered materials, thereby preventing influx of impurities when a dishonest person tries to insert the impurities or tampered materials into a partially or fully emptied beverage bottle.

It is another object of the invention to provide a tamper-proof bottle cap adapted to improve the structure of a bottle cap where a rotational force of an outside cover is transmitted to a valve member, thereby preventing a dishonest person from holding the valve member from the outside.

In accordance with one object of the present invention, there is provided a tamper-proof bottle cap including inner and intermediate covers press-fitted in layers into an opening of a bottle and fixed at a circumference thereof by the opening and sealing member of the bottle, a valve member interposed between the inner and intermediate covers for opening and closing a passage of the inner cover by horizontal sliding, and an outer cover attached to and released from the intermediate cover via meshed coupling, wherein the bottle cap further comprises a baffle valve interposed between the intermediate cover and the valve member, and communicatively and rotatably coupled at one lateral surface thereof to a distal end of the valve member and communicatively and rotatably coupled at the other lateral surface thereof to the outer cover.

In accordance with another object of the present invention, there is provided a tamper-proof bottle cap wherein the baffle valve comprises: a base plate having an inner space at a central lateral surface thereof for a distal end of the valve member to be inserted thereinto and formed with a flange toward an outside of the inner space; a first boss unit extensively and faultily formed toward the other central lateral surface and protrusively formed into the inner circumference and formed with at least one or more hitching jaws that interfere a distal end of the valve member when rotating; and a second boss unit extensively and faultily formed toward the other central lateral surface of the first boss unit and formed with a space opened at the other side for a bottom distal end of the outer cover to be inserted thereinto and formed at an inner circumference of the space with a hitching protruder and interfered when a bottom distal end of the outer cover is rotated.

In accordance with still another object of the invention, there is provided a tamper-proof bottle cap wherein at least one or more stopper protruders are formed at an external surface of a distal end of the valve member relative to the hitching jaw of the first boss unit.

### BRIEF DESCRIPTION OF THE DRAWINGS

For a better understanding of the nature and objects of the present invention, reference should be made to the following detailed description with the accompanying drawings, in which:

FIG. 1 is an exploded perspective view for illustrating a tamper-proof bottle cap according to an embodiment of the present invention;

FIG. 2 is a cross-sectional view for illustrating a coupled state of a tamper-proof bottle cap according to an embodiment of the present invention;

FIG. 3 is a cross-sectional view for illustrating an opened tamper-proof bottle cap according to an embodiment of the present invention;

FIG. 4 illustrates a use state of the present invention;

FIG. 5 is an exploded perspective view for illustrating an example of a tamper-proof bottle cap according to the prior art; and

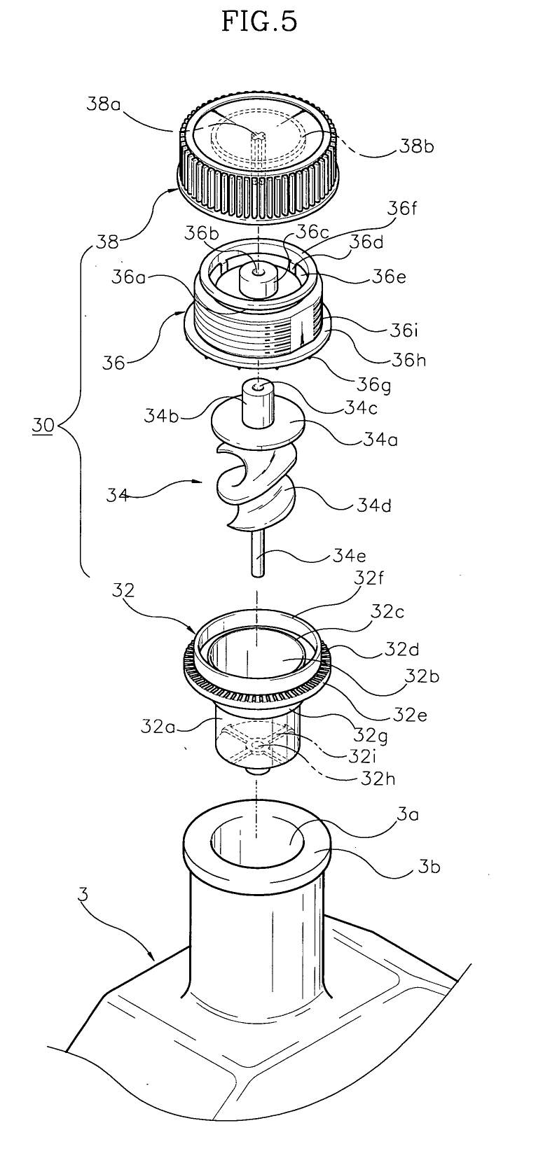

FIG. 6 illustrates a use state of FIG. 5.

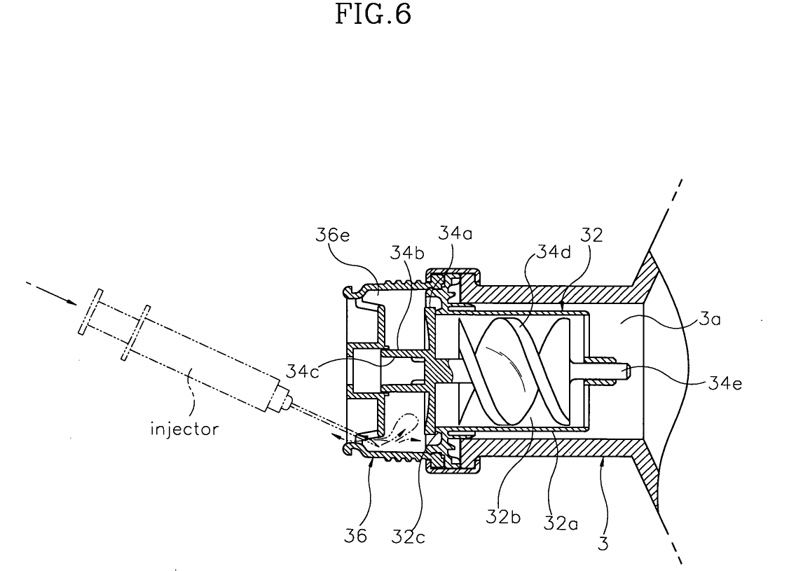

### DETAILED DESCRIPTION OF THE PREFERRED EMBODIMENT

The preferred embodiments of the present invention will now be described in detail with reference to the annexed drawings, where the present embodiment is not limiting the scope of the present invention but is given only as an illustrative purpose.

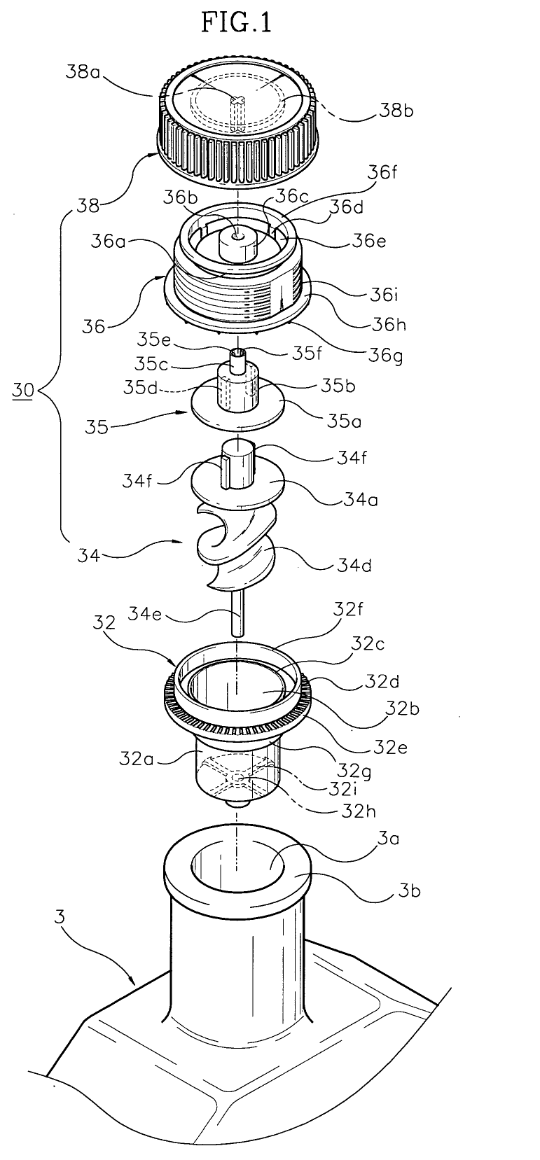

The tamper-proof bottle cap according to the embodiments of the present invention includes, as illustrated in FIGS. 1 to 4, an inner cover (32) insertedly fixed at a lower end of the opening (3a) of the bottle (3) for guiding an outflow of contents thereof, a valve member (34) inserted via an upper side of the inner cover (32) and vertically moving for opening and closing a passage of the inner cover (32) and forming a spiral water current for controlling a current speed when contents of the bottle (3) flow out, an intermediate cover (36) inserted into an upper circumference of the inner cover (32) for guiding the outflow of the contents, and an outer cover (38) opened and closed by threaded engagement at an upper circumference of the intermediate cover (36) for applying pressure to or releasing the valve member (34), and an aluminum sealing member for circumferentially winding and fixing a flange (3b) protrusively formed at an upper circumferential end of the opening (3a) of the bottle (3), the inner cover (32), and flanges (described later) each protrusively formed at a circumference of the intermediate cover (36).

The bottle cap further includes a baffle valve (35) interposed between the valve member (34) and the intermediate cover (36) for transmitting rotational force to the valve member (34).

More particularly, the valve member (34) is integrally formed at a middle stair thereof with a disc-shaped baffle board (34a) having an area for being tightened with or being separated from the contact protruder (32c) protrusively formed at an upper end of the vertical hole (32b) of the inner cover (32). At a middle upper central surface of the baffle board (34a), there is integrally formed an upper support axis (34b) so as to be inserted into a lower center of the intermediate cover (36) for vertical and horizontal movement. A plurality of stopper prods (34f) are vertically formed at a circumferential surface of the upper support axis (34b) each spaced out at a predetermined interval.

At a lower center surface of the baffle board (34a), there is integrally formed a screw unit (34d) so as to be inserted into the vertical hole (32b) of the inner cover (32) for vertical and horizontal movement along with the baffle board (34a) and to form a spiral water current when contents pass therethrough for maintaining a flow speed at a prescribed level. At a lower center of the screw unit (34d) there is integrally formed a lower support axis (34e) so as to be hinged at a support hole (32h) formed at a lower end of the vertical hole (32b) of the inner cover (32) and for a circumference of the screw unit (34d) to supportively maintain a tolerance of, for example, approximately φ1 mm relative to an inner circumference of the vertical hole (34e).

Furthermore, the baffle valve (35) includes a base plate (35a) having an inner space at a central lateral surface thereof for a distal end of the valve member to be inserted thereinto and formed with a flange toward an outside of the inner space, a first boss unit (35b) extensively and faultily formed toward the other central lateral surface and protrusively formed into the inner circumference relative to the stopper prods (34f) of the upper support axis (34b) and formed with at least one or more than one hitching jaw (35d) that interferes with a distal end of the valve member when rotating, and a second boss unit extensively and faultily formed toward the other central lateral surface of the first boss unit (35b) and formed with a space (35e) opened at the other side for the locking axis (38a) of the outer cover (38) to be inserted thereinto and formed at an inner circumference of the space (35e) with a hitching protruder (35f) and interfered with the locking axis when a bottom distal end of the outer cover is rotated.

Preferably, the baffle valve (35) is formed at an inner side of the base plate (35a) and the first boss unit (35b) with an inner space so that the upper support axis (34b) of the valve member (34) can be partially accommodated, and when the upper support axis (34b) is accommodated into said inner space, the first boss unit (35b) is adjusted in length thereof so that the base plate (35a) of the baffle valve (35) and the valve member (34) can be distanced therebetween.

The operation of the invention thus structured will now be explained.

When a consumer rotates the tamper-proof bottle cap along a direction for opening the outer cover (38), the locking axis (38a) of the outer cover (38) and the hitching protruder (35f) of the baffle valve (35) are interfered therebetween to allow the rotational force of the outer cover (38) to be transmitted to the baffle valve (35), such that the outer cover (38) and the baffle valve (35) are communicatively rotated.

Successively, when the baffle valve (35) is rotated, the hitching jaw (35d) of the baffle valve (35) and the stopper prod (34f) of the valve member (34) are mutually interfered to communicatively rotate the valve member (34) such that the rotational force of the outer cover (38) is transmitted to the valve member (34) side from the baffle valve (35).

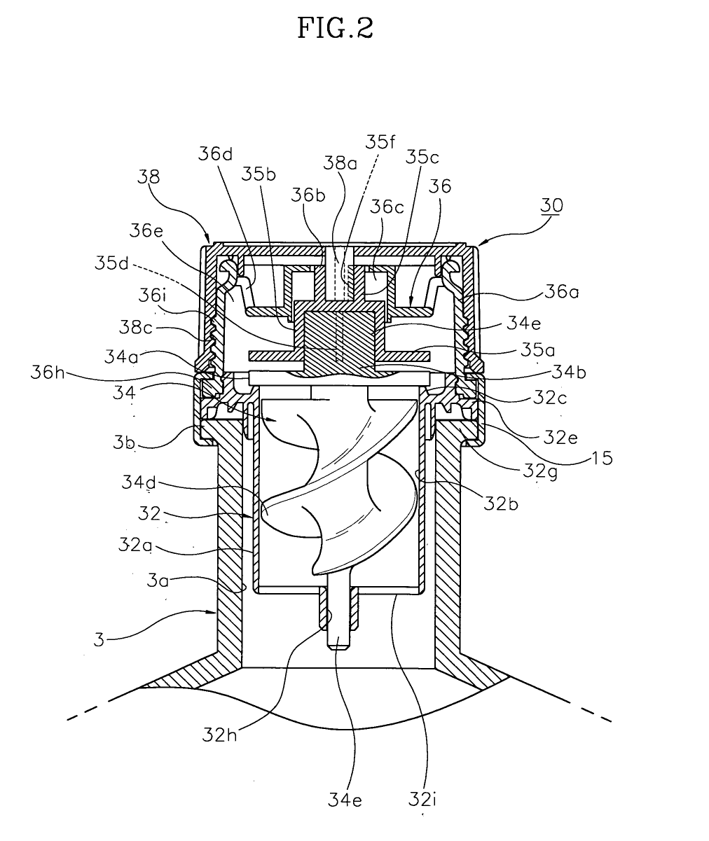

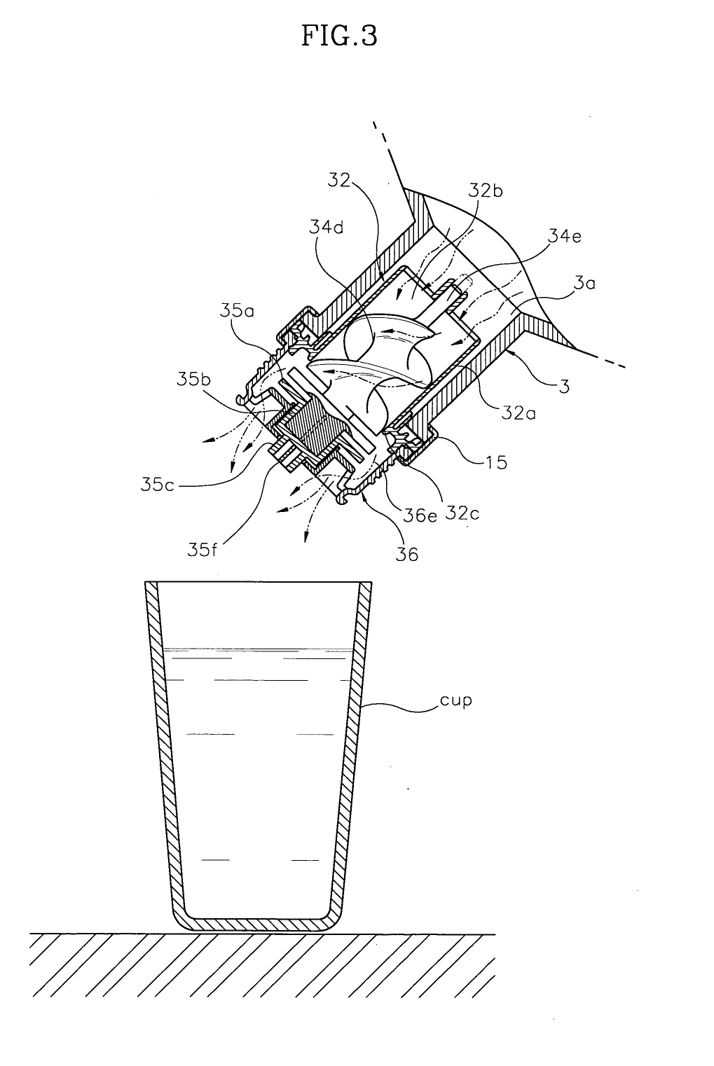

As illustrated in FIG. 2, when a consumer opens the outer cover (38) and tilts the bottle (3) at a prescribed angle (FIG. 3) in order to pour contents of the bottle such as beverage, liquor or the like into a cup, the whole valve member (34) interposed between the intermediate cover (36) and the inner cover (32) is operated downward as long as a predetermined distance in response to its weight of valve member (34) or the fluid pressure generated by the contents in the bottle (3), whereby the baffle board (34a) of the valve member (34) is separated from the contact protruder (32c) of the inner cover (32) at a prescribed distance and the vertical hole (32b) of the inner cover (32) is opened simultaneously. At the same time, the baffle valve (35) coupled to the upper support axis (34b) at the valve member (34) is also lowered in response to the downing of the valve member (34).

In other words, when the bottle (3) is tilted at over a prescribed angle, the upper support axis (34b) of the valve member (34) is moved downward, being inserted between the base plate (35a) of the baffle valve (35) and the first boss unit (35b), and hits the intermediate cover (36) to get stopped thereat. The lower support axis (34e) of the valve member (34) is inserted into the support hole (32h) formed under the vertical hole (32b) of the inner cover (32) and is moved toward the vertical hole (32b), such that the baffle board (34a) of the valve member (34) is distanced from the contact protruder (32c) formed at the upper end of the vertical hole (32b) at a prescribed extent to open an upper opening of the vertical hole (32b), and the screw unit (34d) of the valve member (34) is vertically moved within the vertical hole (32b) at a prescribed distance.

While contents of the bottle are discharged, the contents flow along the spiral passage of the screw unit (34d) at the valve member (34) side to form a spiral fluid current, and the contents passing by the screw unit (34d) flow through an open passage opened between the vertical hole (32b) and the baffle board (34a). Concurrently, the contents pass by the outer side of the base plate (35a) of the baffle valve (35) to be discharged outside of the bottle via an outlet (36e) of the intermediate cover (36).

As a result, the valve member (34) allows the baffle board (34a) of the valve member (34) to open the vertical hole (32b) of the inner cover (32) when the contents such as beverage, liquor or the like in the bottle (3) are poured out, and the screw unit (34d) integrally formed with the baffle board (34a) also allows the flow of the contents passing through the vertical hole (32b) to form a spiral current or to be poured out at a prescribed amount and speed. Furthermore, the valve member (34) helps make a friction sound at a minimal level when the contents are discharged, thereby preventing the discharging contents from making a splash.

When the opening (3a) of the bottle (3) is erected to face upward, the valve member (34) and the baffle valve (35) are lowered by respective weights to prompt the baffle board (34a) to contact the contact protruder (32c) formed at the vertical hole (32b) of the inner cover (32), thereby closing the vertical hole (32b). In this regard, aromas and alcoholic ingredients of the contents in the bottle (3) are prevented from drifting out into the atmosphere, and tampering with foreign objects or fabricated materials can be also avoided in advance.

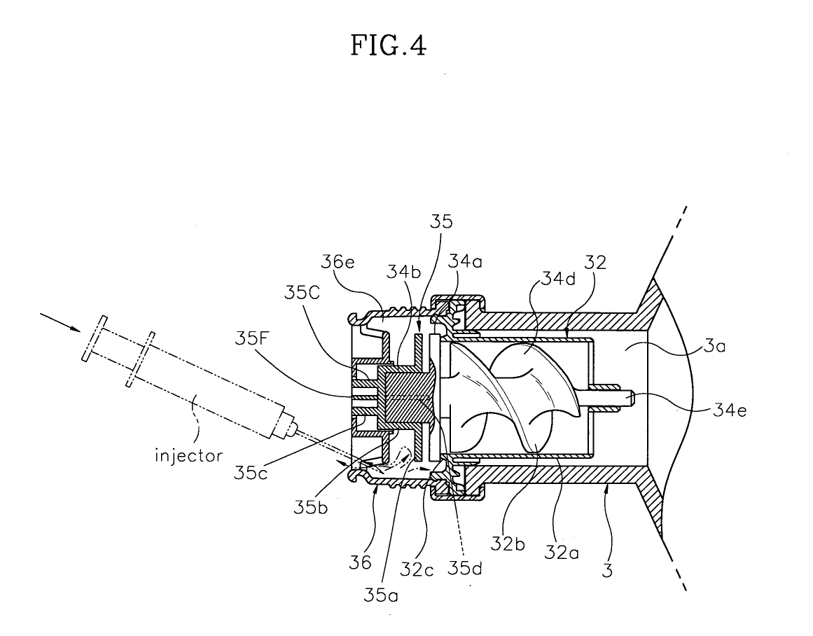

Meanwhile, when a dishonest person tries to maintain an opened state of the valve member (34) in order to input foreign objects or fabricated materials into the bottle by way of a needle or the like while the bottle is tilted as shown in FIG. 4, the baffle board (34a) of the valve member (34) and the base plate (35a) of the baffle valve (35) are pushed inward by resistance of the flow pressure applied to the foreign substances or the fabricated materials to prompt the baffle board (34a) to close the vertical hole (32b) of the inner cover.

In other words, the valve member (34) and the baffle valve (35) are simultaneously pushed by the physical pressure applied to the alien substances to prompt the contact protruder (32c) formed at the vertical hole (32b) of the inner cover (32) to contact the baffle board (34a) tightly and to close the passage of the vertical hole (32b), making it impossible for tampering to occur with other materials.

Furthermore, even if the valve member (34) is held at the outside of bottle (3) to try to open the vertical hole (32b) of the inner cover (32), the vertical hole (32b) cannot be opened by the structural features of the baffle valve (35) such that tampering with other fabricated materials can be avoided beforehand.

As apparent from the foregoing, there is an advantage in the tamper-proof bottle cap according to the present invention thus described in that the cap is structurally fixed to an opening of a bottle to guide the flow of contents in the bottle such as beverage, liquor or the like and is designed to prevent foreign objects or fabricated materials from entering the bottle from the outside, wherein a valve member opens and closes a vertical hole of an inner cover and simultaneously controls the flow of contents discharged via the vertical hole, and a baffle valve coupled to an upper side of the valve member is made to transmit a rotational force of an outer cover and to block the valve member from the outside, such that a spiral fluid current can be formed regardless of the tilting angle of the bottle when the contents of the bottle such as beverage, liquor or the like are poured out, whereby speed of fluid current of the contents can be constantly maintained, making it possible to discharge the contents in an appropriate quantity and to reduce the friction sound.

There is another advantage in that the valve member and the baffle valve are closed by resistance generated by the input of foreign substances, thereby preventing the contents from being tampered with foreign materials.

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

1. A tamper-proof bottle cap, comprising:
inner and intermediate covers press-fitted in layers into an opening of a bottle and fixed at a circumference thereof by the opening and a sealing member of the bottle;
a valve member interposed between the inner and intermediate covers for opening and closing a passage of the inner cover by horizontal sliding; and
an outer cover attached to and released from the intermediate cover via meshed coupling, wherein the bottle cap further comprises a baffle valve interposed between the intermediate cover and the valve member, and communicatively and rotatably coupled at one lateral surface thereof to a distal end of the valve member and communicatively and rotatably coupled at the other lateral surface thereof to the outer cover.

2. The cap as defined in claim 1, wherein the baffle valve comprises:
a base plate having an inner space at a central lateral surface thereof for a distal end of the valve member to be inserted thereinto and formed with a flange toward an outside of the inner space;
a first boss unit extensively and faultily formed toward the other central lateral surface and protrusively formed into the inner circumference and formed with at least one or more hitching jaws that interfere with a distal end of the valve member when rotating; and
a second boss unit extensively and faultily formed toward the other central lateral surface of the first boss unit and formed with a space opened at the other side for a bottom distal end of the outer cover to be inserted thereinto and formed at an inner circumference of the space with a hitching protruder and interfered when a bottom distal end of the outer cover is rotated.

3. The cap as defined in claim 1 further comprising at least one or more stopper protruders formed at an external surface of a distal end of the valve member relative to the hitching jaw of the first boss unit.
